(19) United States
(12) Patent Application Publication
(10) Pub. No.: US 2023/0007603 A1
(43) Pub. Date: Jan. 5, 2023

(54) METHODS FOR ENABLING A REDUCED BANDWIDTH WIRELESS DEVICE TO ACCESS A CELL

(71) Applicant: Telefonaktiebolaget LM Ericsson (publ), Stockholm (SE)

(72) Inventors: Yutao SUI, Solna (SE); Yi-Pin Eric WANG, Fremont, CA (US); Johan LING, Järfälla (SE); Andreas HÖGLUND, Solna (SE); Olaf LIBERG, Enskede (SE); Yi-Ju CHEN, Solna (SE); Mohammad MOZAFFARI, Fremont, CA (US)

(21) Appl. No.: 17/782,895

(22) PCT Filed: Dec. 7, 2020
(86) PCT No.: PCT/SE2020/051173

§ 371 Date: Jun. 6, 2022

Related U.S. Application Data
(60) Provisional application No. 62/945,439, filed on Dec. 9, 2019.

(51) Int. Cl. H04W 56/00; H04W 72/04

(52) U.S. Cl. CPC H04W 56/001; H04W 72/0446; H04W 72/0453

(57) ABSTRACT

A method of operating a wireless device in a wireless communication network. The method includes detecting first synchronization signaling of a first cell on first time and frequency resources. The first synchronization signaling comprises at least a first synchronization signal and a second synchronization signal. The method further includes detecting indication signaling on second time and frequency resources. The second time and frequency resources are derived based on the first time and frequency resources. The method further includes accessing the first cell if the indication signaling is detected on the second time and frequency resources. Accessing the first cell includes decoding a first system information message on a broadcast channel of the first cell. The first system information message indicates time and frequency resources of a first resource set. The disclosure also pertains to related devices and methods.

### TECHNICAL FIELD

This disclosure pertains to the field of wireless communication networks and more particularly to methods and apparatuses for enabling a reduced bandwidth wireless device to access a cell in a wireless communication network such as a New Radio (NR) wireless communication network.

### BACKGROUND

In NR, when an NR User Equipment (UE) tries to access a cell, it needs to detect a Synchronization Signal Block (SSB). The SSB comprises a Primary Synchronization Signal (PSS), a Secondary Synchronization Signal (SSS), and a Physical Broadcast Channel (PBCH). An illustration of the NR SSB is given in FIG. 1. As shown, the SSB is mapped to 4 orthogonal frequency-division multiplexing (OFDM) symbols in the time domain and 20 Resource Blocks (RBs) in the frequency domain. Each RB comprises 12 subcarriers, which means that the SSB is mapped to 240 subcarriers in the frequency domain. The PSS is mapped to the first OFDM symbol and the SSS is mapped to the third OFDM symbol. They are both mapped to 127 subcarriers in the frequency domain. These 127 subcarriers are placed in the middle of the 240 subcarriers of the SSB. The PBCH is mapped to the second, third and fourth OFDM symbol. The PBCH is mapped to 20 RBs in the second and fourth OFDM symbol. In the third OFDM symbol, the PBCH is mapped to the 4 RBs above and the 4 RBs below the SSS.

Multiple SSBs may be transmitted within e.g. a 5 ms time window, e.g. in the first four slots in the 5 ms time window. These multiple SSBs are further transmitted periodically in an SS-burst-set period of e.g. 20 ms intervals. FIG. 2 illustrates one example of time domain occurrence of the SSBs. The size of the time window and the intervals may be configured by the network.

System Information (SI) in NR is delivered through a Master Information Block (MIB) and System Information Blocks (SIBs).

The MIB is transmitted on the PBCH within the SSB. It contains a small amount of information, necessary for the UE to receive the remaining SI in the SIBs. The MIB contains a configuration of a Control Resource Set #0 (CORESET #0) and Search Space #0. The CORESET #0 is a time and frequency region where the UE monitors for a Physical Downlink Control Channel (PDCCH). The Search Space defines e.g. monitoring locations of the CORESET in time.

The structure of the MIB is specified in the standard. Therefore, changes between releases may break backwards compatibility. Currently, the smallest possible CORESET #0 size in the frequency domain is 24 RBs, while the MIB occupies 20 RBs. All the bits in the MIB have a specific meaning defined by the current NR standard, except one bit which is still reserved.

The SIBs are scheduled in a similar way as normal data transmission but are repeated periodically by being scheduled in a SI window. The PDCCH indicates to the UE that a Physical Downlink Shared Channel (PDSCH) is to be received, where the PDSCH may contain the SIB (or SIBs).

Implementation of low-cost and/or low-complexity UEs is needed for the 5G system, e.g., for massive industrial sensors deployment or wearables. NR-Light has been used as the running name for the discussion of such low-cost and/or low-complexity UEs in 3GPP. NR-Light relates to reduced capability wireless devices and is therefore also referred to as NR-Redcap. NR-Light is a new feature that is under discussion and could be introduced as early as in 3GPP Release 17. NR-Light is intended for use cases that do not require a device to support full-fledged NR capability and IMT-2020 performance requirements. For example, the data rate may not need to reach above 1 Gbps, and the latency may not need to be as low as 1 ms. By relaxing the data rate and latency targets, NR-Light enables low-cost and/or low-complexity UE implementation. In 3GPP Release 15, an NR UE is required to support 100 MHz carrier bandwidth in Frequency Range (FR) 1 (from 410 MHz to 7125 MHz) and 200 MHz carrier bandwidth in FR2 (from 24.25 GHz to 52.6 GHz). For a UE operating in NR-Light (e.g. an NR-Light UE), supporting 100 MHz or 200 MHz bandwidth is superfluous. For example, a UE bandwidth of 8.64 MHz might be sufficient if the use cases do not require a data rate higher than 20 Mbps. A reduced UE bandwidth may result in cost and/or complexity reduction and a possible energy consumption reduction.

One of the initial cell access steps is for the UE to acquire SIB type 1 (SIB1), which is acquired after the UE acquires the MIB. SIB1 is scheduled through PDCCH using Search Space #0 associated with CORESET #0. In NR, CORESET #0 has bandwidths 4.32 MHz, 8.64 MHz, or 17.28 MHz in FR1, and 34.56 MHz or 69.12 MHz in FR2. The bandwidth of CORESET #0 depends on the subcarrier spacing indicated in MIB (by parameter subCarrierSpacingCommon) and is configured by the network.

For example, if CORESET #0 uses 30 kHz subcarrier spacing for PDCCH, the bandwidth of CORESET #0 can be either 8.64 MHz or 17.28 MHz. The network may choose either bandwidth option. Between the two options, some implementation consideration may favor the configuration of 17.28 MHz bandwidth for CORESET #0. For example, with 30 kHz subcarrier spacing and 17.28 MHz CORESET #0 bandwidth, PDCCH can operate with Aggregation Level (AL) 16, which offers a higher PDCCH coverage. In comparison, configuring CORESET #0 with bandwidth 8.64 MHz supports AL 8 when PDCCH is configured with 30 kHz subcarrier spacing, which results in approximately 3 dB coverage reduction compared to AL 16. Furthermore, using a higher CORESET #0 bandwidth gives rise to higher scheduling capacity. However, using 17.28 MHz bandwidth, may result in that CORESET #0 cannot be used by low-cost and/or low-complexity UEs, such as e.g. NR-Light UEs. These UEs may only support smaller bandwidths, especially considering that currently only an interleaved mapping is supported by CORESET #0, which means a PDCCH candidate may span the entire bandwidth of CORESET #0.

A PDCCH mapped to resources in CORESET #0 may be used to transmit Downlink Control Information (DCI) which schedules PDSCH carrying SIB1. In that case, the DCI is masked with a SI Radio Network Temporary Identifier (SI-RNTI). This means that the Cyclic Redundancy Check (CRC) of the PDCCH is scrambled with SI-RNTI.

Currently, DCI format 1_0 with CRC scrambled by SI-RNTI is used to schedule the SIBs in NR. DCI format 1_0 with CRC scrambled by SI-RNTI for scheduling SIB1 is given in Table 1.

TABLE 1
DCI format 1_0 with CRC scrambled by SI-RNTI which used to schedule SIB1

| Field (Item) | Bits | Reference |
|---|---|---|
| Frequency domain | Variable | Variable with DL BWP N_RB |
| resource assignment | | ┌log₂(N_{RB}^{DL, BWP}(N_{RB}^{DL, BWP} + 1)/2)┐ |
| | | N_{RB}^{DL, BWP} indicates the size of CORESET 0 |
| Time domain resource | 4 | Carries the row index of the items in Default |
| assignment | | PDSCH time domain table given in 38.214 |
| VRB-to-PRB mapping | 1 | According to 38.212 Table 7.3.1.1.2-33 |
| | | 0: Non-Interleaved |
| | | 1: Interleaved |
| Modulation and coding | 5 | 38.214 - Table 5.1.3.1-1: MCS index |
| scheme | | table 1 for PDSCH |
| Redundancy Version | 2 | |
| System Information | 1 | 0: SIB1 |
| Indicator | | 1: SI messages |
| Reserved | 15 | Reserved |

All NR cells may not support NR-Light UEs (e.g. having reduced bandwidth). The less time the NR-Light UE spends on trying to access cells which do not support NR-Light UEs, the less power it will consume.

### SUMMARY

There currently exist certain challenges. Therefore, it is an object of the present disclosure to enable a wireless device to identify whether a cell supports wireless devices with specific capabilities, and to enable a quick cell search, which may reduce the power consumption of the wireless device during the cell search.

There is disclosed a method of operating a wireless device in a wireless communication network. The method may comprise detecting first synchronization signaling of a first cell on first time and frequency resources. The first synchronization signaling may comprise at least a first synchronization signal and a second synchronization signal. The method may further comprise detecting indication signaling on second time and frequency resources. The second time and frequency resources may be derived based on the first time and frequency resources. The method may further comprise accessing the first cell if the indication signaling is detected on the second time and frequency resources. Accessing the first cell may comprise decoding a first system information message on a broadcast channel of the first cell. The first system information message may indicate time and frequency resources of a first resource set.

There is disclosed a method of operating a network node in a wireless communication network. The method may comprise transmitting first synchronization signaling on first time and frequency resources. The first synchronization signaling may comprise at least a first synchronization signal and a second synchronization signal. The method may further comprise transmitting indication signaling on second time and frequency resources. The second time and frequency resources may be derived based on the first time and frequency resources. The method may further comprise transmitting a first system information message on a broadcast channel. The first system information message may indicate time and frequency resources of a first resource set. The method may further comprise communicating with a wireless device based on the transmitted indication signaling.

There is disclosed a wireless device configured for operation in a radio access network. The wireless device may be configured to perform any of the methods of operating a wireless device described herein. The wireless device may be implemented as a user equipment or a terminal. The wireless device may comprise, and/or be adapted to utilize, processing circuitry and/or radio front-end circuitry, in particular a transceiver and/or transmitter and/or receiver, for receiving the signaling and accessing the cell.

There is disclosed a network node configured for operation in a radio access network. The network node may be configured to perform any of the methods of operating a network node described herein. The network node may comprise, and/or be adapted to utilize, processing circuitry and/or radio front-end circuitry, in particular a transceiver and/or transmitter and/or receiver, for communicating, in particular for transmitting the signaling and communicating with the wireless device.

Certain embodiments may enable a quick cell search, which may reduce the power consumption of the wireless device during the cell search.

Generally, all terms used are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention may best be understood by referring to the following description and accompanying drawings that are used to illustrate particular embodiments of the invention. In the drawings:

FIG. 1 illustrates an NR SSB.

FIG. 2 illustrates an example of time domain NR SSB configuration.

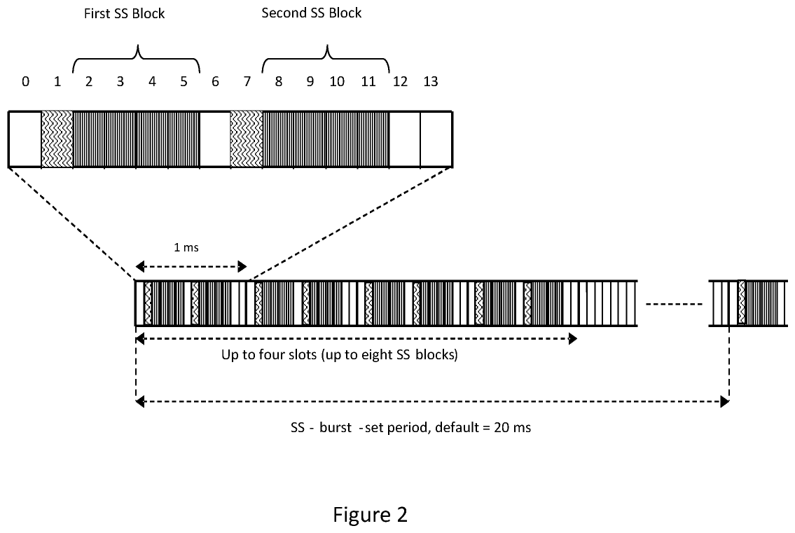

FIG. 3 is a flowchart illustrating a method of operating a wireless device according to an embodiment.

FIG. 4 is a flowchart illustrating a method of operating a network node according to an embodiment.

FIG. 5 illustrates example placement of indication signaling.

FIG. 6 illustrates a wireless network in accordance with some embodiments.

FIG. 7 illustrates a user equipment in accordance with some embodiments.

FIG. 8 illustrates a telecommunication network connected via an intermediate network to a host computer in accordance with some embodiments.

FIG. 9 illustrates a host computer communicating via a base station with a user equipment over a partially wireless connection in accordance with some embodiments.

FIGS. 10-13 are flowcharts illustrating methods implemented in a communication system including a host computer, a base station and a user equipment in accordance with some embodiments.

### DETAILED DESCRIPTION

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

In the following, concepts and approaches are described in the context of NR technology. However, the concepts and approaches may be applied to other radio access technologies (RATs). Moreover, the concepts and approaches are discussed in the context of communication between network nodes (e.g. gNBs or Base Stations (BS)) and a wireless device (e.g. UE) for downlink and uplink subject transmission, but may also be applied to a sidelink scenario, in which the involved network nodes may be wireless devices.

In order for a wireless device with specific capabilities (e.g. with reduced complexity and/or reduced cost and/or reduced bandwidth) to access a cell, the wireless device needs to know whether the cell supports this wireless devices. Throughout this disclosure, the wireless device may correspond to a wireless device with specific capabilities, a low cost and/or low complexity wireless device, a wireless device which operates using a reduced bandwidth, and/or a wireless device operating in a coverage enhancement mode. An example of the wireless device may be a NR-Light UE (which may also be referred to as a NR-Redcap UE). Throughout this disclosure, the network node may correspond to a network node which supports wireless devices with specific capabilities, low cost and/or low complexity wireless devices, wireless devices which operates using a reduced bandwidth, and/or wireless devices operating in a coverage enhancement mode. An example of the network node may be a gNB. An example of the network node may be a gNB which may or may not support NR-Light UEs.

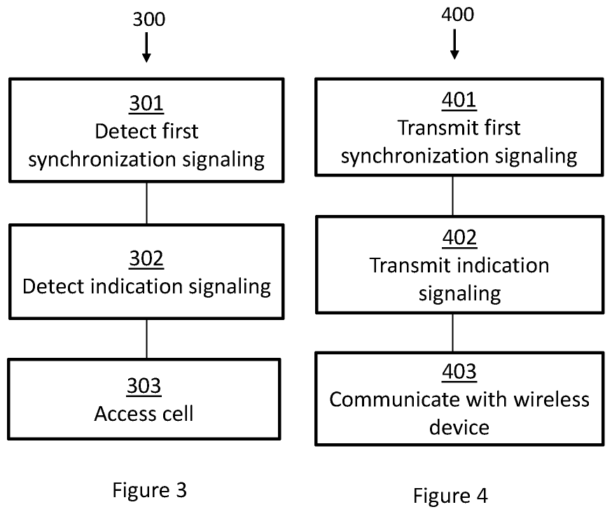

A reduced bandwidth may correspond to a reduced bandwidth compared to the bandwidth of the frequency band of the first cell referred to in the method 300 described below with reference to FIG. 3. A reduced bandwidth may correspond to a reduced bandwidth compared to the bandwidth of the time and frequency resources of the first resource set referred to in the method 300 described below with reference to FIG. 3. A reduced bandwidth may correspond to a reduced bandwidth compared to what is required by the wireless device to access the cell referred to in the method 300 described below with reference to FIG. 3. A reduced bandwidth may correspond to a reduced bandwidth compared to a bandwidth part of the cell referred to in the method 300 described below with reference to FIG. 3. A reduced bandwidth may correspond to a reduced bandwidth compared to the bandwidth of CORESET #0.

As one example, the NR-Light UE (which is an example of the wireless device in the method 300 described below with reference to FIG. 3) needs to know whether an NR cell supports NR-Light UEs (e.g. by supporting a reduced bandwidth). In the current NR design, the NR UE detects the SSB and reads the MIB. One possible solution is to use the MIB to indicate whether the cell supports NR-Light. However, since there is only one spare bit in MIB, it may not be future proof to use this bit as indication.

Another example solution is to use system information (e.g. MIB or SIB(s)) to indicate that the cell supports wireless devices with specific capabilities, e.g. that an NR cell supports NR-Light. However, this solution may require that the wireless device (e.g. the NR-Light UE) reads several channels/signals in order to determine whether the cell supports the wireless device (e.g. the NR-Light UE). For example, the NR-Light UE may need to decode both the MIB in the PBCH and one or more SIBs to determine whether the cell supports NR Light. This process will consume a significant amount of energy from the wireless device during the cell search.

In the present disclosure, indication signaling is introduced which may be placed near or within existing synchronization signaling (such as e.g. SSB). After the wireless device detects a cell by detecting the synchronization signaling, it may look for the indication signaling. If the indication signaling is present, the wireless device may proceed to further access the cell, e.g. by decoding system information. If the indication signaling is not detected, the wireless device notices that the cell does not support the wireless device and may try to find another synchronization signaling of another cell, for example at another frequency. The indication signaling may enable a quick cell search of the wireless device. This may reduce the power consumption of the wireless device during the cell search.

FIG. 3 is a flowchart illustrating a method (300) of operating a wireless device in a wireless communication system, in accordance with one embodiment. The method (300) may comprise detecting (301) first synchronization signaling of a first cell on first time and frequency resources. The first synchronization signaling may comprise at least a first synchronization signal and a second synchronization signal. The method may further comprise detecting (302) indication signaling on second time and frequency resources. The second time and frequency resources may be derived based on the first time and frequency resources. The method may further comprise accessing (303) the first cell if the indication signaling is detected on the second time and frequency resources.

In general, time and frequency resources may be viewed as a time-frequency grid. In the time domain, the physical resources may be divided into OFDM symbols. In the frequency domain, the physical resources may be divided into subcarriers. Twelve subcarriers may further build one RB. One field in the gird corresponding to one subcarrier and one OFDM symbol may be referred to as a resource element (RE). The time domain may further use a frame structure. The time domain may comprise a plurality of radio frames, where each radio frame may e.g. span over 10 ms in time. Each radio frame may contain a plurality of subframes (e.g. 10 subframes), each subframe may e.g. span over 1 ms. Each subframe may contain a plurality of slots (e.g. 1 for 15 kHz subcarrier spacing, 2 for 30 kHz subcarrier spacing etc.). Each slot may contain a plurality of OFDM symbols (e.g. 14 OFDM symbols using a normal cyclic prefix).

A cell may be operated by a network node. The cell may correspond to a carrier, e.g. one carrier of a plurality of carriers in a carrier aggregation system. The cell may relate to a carrier frequency, which may correspond to the frequency band which the cell is operated in. The frequency band of the cell may have a corresponding bandwidth. The network node may transmit signaling within the frequency band of the cell. The frequency band may have a corresponding lowest and a highest frequency, which may e.g. correspond to the lowest and highest subcarrier used for transmission. The bandwidth of the frequency band may correspond to the frequency range from the lowest to the highest frequency of the cell. The bandwidth may be indicated by a frequency range, a number of subcarriers, and/or a number of RBs. The cell may have a corresponding cell identity, e.g. a Physical Layer Cell Identity (ID). The network node which operates the cell may transmit e.g. synchronization signaling within the frequency band of the cell.

The first cell referred to in the method 300 may be a cell operated by a first network node. Another cell may be operated by another network node. The first cell and the another cell may be operated by the same network node, e.g. the first network node. The first cell and the another cell may use different frequency bands. The first cell and the another cell may correspond to different carriers in a carrier aggregation system. The different frequency bands may be adjacent to each other or separated by a frequency offset. The first cell and the another cell may have different cell identities. The first cell and the another cell may have different synchronization signaling, which may use different time and frequency resources. The first cell and/or the another cell may or may not support two types of wireless devices. The first cell and/or the another cell may or may not support wireless devices with specific capabilities, such as e.g. reduced complexity and/or cost and/or bandwidth. The first cell and/or the another cell may or may not correspond to an NR cell. The first cell and/or the another cell may or may not correspond to an NR cell which supports NR-Light UEs (also referred to as NR-Redcap UEs).

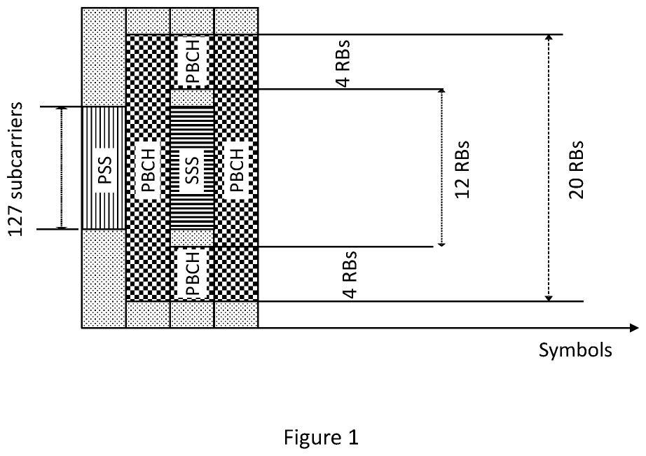

Synchronization signaling may comprise a plurality of synchronization signals, e.g. at least two synchronization signals. The synchronization signaling may further comprise signaling over a broadcast channel. The synchronization signaling may be transmitted using one or more time and frequency resources. The time and frequency resources of the synchronization signaling may be within the frequency band of the related cell, e.g. the cell operated by the network node which transmits the synchronization signaling. The time and frequency resources of the synchronization signaling may correspond to one or more OFDM symbols in time. The time and frequency resources of the synchronization signaling may correspond to one or more subcarriers and/or one or more RBs in frequency. The synchronization signaling may be transmitted periodically. The synchronization signaling may be transmitted at one occasion or periodically over a plurality of slots and/or subframes and/or radio frames. The synchronization signaling may correspond to the NR SSB (for example as described above with reference to FIG. 1). The time and frequency resources of the synchronization signal may correspond to the time and frequency resources of the full SSB (for example four OFDM symbols in time and 20 RBs in frequency) or the time and frequency resources of the PSS, SSS, and PBCH within the SSB. The synchronization signaling may be used for initial detection of the cell, e.g. during a cell search. The synchronization signaling may be used for synchronizing a wireless device to the network node of the cell. The synchronization signaling may be used for signal quality estimations.

The first synchronization signaling referred to in the method 300 may comprise at least a first synchronization signal and a second synchronization signal. The first synchronization signaling may be signaled in first time and frequency resources. The first time and frequency resources may comprise time and frequency resources which are adjacent to each other, e.g. resources which are in adjacent OFDM symbols and/or subcarriers and/or RBs. The first time and frequency resources may comprise time and frequency resources which are not adjacent to each other. The first time and frequency resources may occur periodically. The first synchronization signaling may correspond to an SSB signaling of the first cell, e.g. when the first cell may be an NR cell operated by a gNB. The first synchronization signaling may correspond to the PSS and the SSS of the first cell. The first synchronization signaling may correspond to the PSS, the SSS, and the PBCH of the first cell.

A synchronization signal may be used for acquiring symbol and/or frequency synchronization to a cell. Being synchronized to a cell may correspond to being synchronized to a frame timing of the cell. The frame timing may correspond to a radio frame timing, a subframe timing, a slot timing and/or an OFDM symbol timing of the cell. The synchronization signal may be used for identifying the identity of the cell. One or more synchronization signals may be used for identifying the identity of the cell. One or more synchronization signals may be used, together with one or more other signals, for identifying the identity of the cell. The synchronization signal may be based on one or more sequences. The synchronization signal may be based on one or more pair of sequences. The one or more sequences and/or one or more pair of sequences may be one or more Zadoff-Chu sequences, maximum-length sequences (m-sequences), pseudo-random sequences and/or predefined sequences. A wireless device may be preconfigured with one or more sequences of the one or more synchronization signal. The wireless device may be able to detect the synchronization signal and/or sequence e.g. by using a matched filter and/or correlation. By detecting the one or more synchronization signal, the wireless device may synchronize to the cell. By detecting the one or more synchronization signals and/or sequences, the wireless device may derive the cell identity. The synchronization signal may be precoded using a precoder. The precoder may map the antenna ports of the synchronization signal to physical antennas. The precoder may map the synchronization signal to time and frequency resources, e.g. specific resource elements.

Throughout this disclosure, a sequence may correspond to a sequence of symbols. The synchronization signal may be based on sequences by using the sequences to build the synchronization signals. One or more sequences out of a set of sequences may be used for building the synchronization signal, e.g. by selecting which of the one or more sequences out of the set of sequences to base the synchronization signal on. The sequences and/or signals may be known by both the wireless device and the network node. By correlating a received signal with a representation of the synchronization signal, the wireless device may be able to detect the received signal as the synchronization signal, and it may further be able to derive the corresponding sequence.

The first synchronization signal referred to in the method 300 may be based on a specific sequence in a set of multiple sequences. The first synchronization signal may be based on e.g. one Zadoff-Chu sequence in a set of one or more Zadoff-Chu sequences. The first synchronization signal may be based on one sequence in a set of three sequences. The set of sequences used for the first synchronization signal may include fewer sequences than the set of sequences used for the second synchronization signal. The first synchronization signal may be used for initial detection of the synchronization signaling. The wireless device may start by searching for the first synchronization signal. If the first synchronization signal is detected, the first synchronization signaling may be detected. If the first synchronization signal is detected, the wireless device may detect the second synchronization signal. The first synchronization signal may correspond to a PSS, e.g. an NR PSS.

The second synchronization signal referred to in the method 300 may differ from the first synchronization signal. The second synchronization signal may be based on one or more m-sequences. The second synchronization signal may be based on a pair of m-sequences. The second synchronization signal may be based on one or more sequence in a set of sequences, where the set of sequences may be larger than the set of sequences used for the first synchronization signal. The set of sequences used for the second synchronization signal may include 127 sequences. The set of sequences used for the second synchronization signal may include 127 pairs of sequences. The wireless device may detect the second synchronization signal after the first synchronization signal is detected. The wireless device may detect the second synchronization signal when the first synchronization signal is detected. The second synchronization signal may correspond to an SSS, e.g. an NR SSS.

The first and second synchronization signals referred to in the method 300 may be used for deriving the cell identity of the first cell. The identity may be derived based on which sequence in the set of sequences that are used. The first and second synchronization signal may correspond to the PSS and the SSS of the first cell.

The step 301 of detecting the first synchronization signaling may comprise detecting the first synchronization signal, e.g. without detecting the second synchronization signal. In one example, detecting the first synchronization signaling (e.g. the SSB) may comprise detecting the PSS, e.g. without detecting the SSS. Detecting the first synchronization signaling may comprise detecting both the first synchronization signal and the second synchronization signal. In one example, detecting the first synchronization signaling (e.g. the SSB) may comprise detecting both the PSS and the SSS. Detecting a signal or a signaling may involve receiving, identifying, finding, decoding, reading etc. the signal or signaling. The detection may be based on a matched filter or a correlation of the received signal with a preconfigured version of the signal. Detecting a signal or a signaling may involve detecting the signal of signaling after searching, monitoring, scanning, etc. for the signal or signaling in a plurality of time and/or frequency resources. The search may be part of a cell search, where the wireless device may scan different frequency regions for the first synchronization signal. If the wireless device detects the first synchronization signal it may continue to detect e.g. the second synchronization signal. If the wireless device does not detect the first synchronization signaling (e.g. if the first and/or second synchronization signal is not detected), the wireless device may search for another synchronization signaling of another cell in another frequency region. Detecting the first synchronization signaling may comprise accumulating the first synchronization signaling over a plurality of time and frequency resources occurring periodically in time.

The wireless device may, after detecting synchronization signaling (for example as in step 301 in the method 300), detect indication signaling (for example as in step 302 in the method 300) related to the synchronization signaling, e.g. being transmitted by the same network node and/or in the same cell. The wireless device may, after detecting the synchronization signaling of the cell, detect the indication signaling. The wireless device may, after detecting the first synchronization signal of the first cell, detect the indication signaling. The wireless device may, after detecting the first synchronization signal and the second synchronization signal of the first cell, detect the indication signaling. The wireless device may, after detecting the first synchronization signal of the first cell, detect the indication signaling without detecting the second synchronization signal. The indication signaling referred to in the method 300 may correspond to an indication signal. The indication signaling may correspond to a synchronization signal. The indication signaling may correspond to a third synchronization signal of the synchronization signaling. The indication signaling may be detected by using matched filter and/or a correlation. The indication signaling may be detected by accumulating the indication signaling over a plurality of time and frequency resources occurring periodically in time. If the indication signaling is not detected on the second time and frequency resources, the method (300) may further comprise searching for another synchronization signaling of another cell, e.g. at another frequency. If the indication signaling is not detected on the second time and frequency resources, it may correspond to an indication that the cell does not support wireless devices with specific capabilities. The indication signaling may not be detected even though the synchronization signaling is detected. The searching for another cell may be performed at another frequency band than where the synchronization signaling was detected.

The indication signaling referred to in the method 300 may be signaled in second time and frequency resources which may differ from the first time and frequency resources referred to in the method 300. The second time and frequency resources may correspond to one or more OFDM symbols in time. The second time and frequency resources may correspond to one or more subcarriers and/or one or more RBs in frequency. The second time and frequency resources may be adjacent in time to the first time and frequency resources, e.g. in the OFDM symbols preceding or following the first time and frequency resources. The second time and frequency resources may be adjacent in frequency to the first time and frequency resources, e.g. in the subcarriers and/or RBs preceding or following the first time and frequency resources. The second time and frequency resources may be adjacent in time and/or frequency to the time and frequency resources of e.g. the first synchronization signal, the second synchronization signal, and/or the broadcast channel. The second time and frequency resources may be separated from the first time and frequency resources by one or more OFDM symbols and/or one or more subcarriers and/or one or more RBs. The second time and frequency resources may at least partially overlap in time with the first time and frequency resources, e.g. by both having at least a subset of the time and frequency resources allocated in the same one or more OFDM symbols. The second time and frequency resources may at least partially overlap in frequency with the first time and frequency resources, e.g. by both having at least a subset of the time and frequency resources allocated in the same one or more subcarriers and or RBs.

In the method 300, after detecting 301 the first synchronization signaling in the first time and frequency resources, the wireless device may derive the second time and frequency resources based on the first time and frequency resources. The second time and frequency resources may be derived based on the time and frequency resources of a signal and/or channel related to the first synchronization signaling, e.g. comprised in the first synchronization signaling. The second time and frequency resources may be derived based on time and frequency resources of the first synchronization signal. The second time and frequency resources may be derived based on time and frequency resources of the second synchronization signal. The second time and frequency resources may be derived based on time and frequency resources of the broadcast channel related to the first synchronization signaling. The second time and frequency resources referred to in the method 300 may be preconfigured based on the first time and frequency resources. There may be a preconfigured or predefined rule or vector which points out the second time and frequency resources based on the first time and frequency resources. The predefined rule or vector may point out the second time and frequency resources based on the time and frequency resources of the first and/or second synchronization signal. The predefined rule or vector may point out the second time and frequency resources based on the time and frequency resources of the broadcast channel. The second time and frequency resources may be mapped to a predefined number of OFDM symbols and/or subcarriers and/or RBs. The predefined number of OFDM symbols may be based on the bandwidth capability of the wireless device. The predefined number of OFDM symbols may not exceed the number of OFDM symbols used by the first synchronization signal, the second synchronization signal and the broadcast channel. Extending the reception time to OFDM symbols outside the OFDM symbols used for the first synchronization signal, the second synchronization signal and/or the broadcast channel may have a negative impact on the energy consumption and/or battery life of the wireless device. The second time and frequency resources may be allocated using a predefined distance from the first time and frequency resources, the time and frequency resources of the first synchronization signal, time and frequency resources of the second synchronization signal, and/or the time and frequency resources of the broadcast channel. This distance may be defined in number of OFDM symbols and/or number of subcarriers, and/or number of RBs between the second time and frequency resources and the first time and frequency resources, the time and frequency resources of the first synchronization signal, time and frequency resources of the second synchronization signal, and/or the time and frequency resources of the broadcast channel. This distance may be zero in time, which may indicate that the time and frequency resources are adjacent in time. This distance may be zero in frequency, which may indicate that the time and frequency resources are adjacent in frequency.

The indication signaling referred to in the method 300 may be used to indicate that a cell supports wireless devices with specific capabilities. The indication signaling may be used to indicate that a cell supports wireless devices which have a reduced complexity, a reduced cost and/or a reduced bandwidth. In one example the indication signaling may correspond to an SSS-L signal. The SSS-L signal may be transmitted by a network node near or within an SSB to indicate that the cell supports e.g. NR-light UEs (also referred to as NR-Redcap UEs). Being transmitted within the SSB may correspond to using some or all of the OFDM symbols and RBs within the 20 RBs and four symbols allocated by an SSB, which are not allocated by the PSS, SSS and PBCH. Near the SSB may correspond to adjacent to the SSB or separated by a small gap in time and/or frequency. The gap may be smaller than the periodicity of the SSB.

The indication signaling referred to in the method 300 may be based on one or more m-sequences e.g. in a set of m-sequences. The indication signaling may be based on one or more pairs of m-sequences e.g. in a set of pairs of m-sequences. The indication signaling may be based on the same sequence(s) as the first synchronization signal, e.g. the same Zadoff-Chu sequence(s). The indication signaling may be based on the same sequence(s) as the second synchronization signal, e.g. the same m-sequence(s). The indication signaling may be based on the same pair of sequence(s) as the second synchronization signal, e.g. pairs of m-sequence(s). The indication signaling may be based on another sequence(s) than the second synchronization signal, from the set of m-sequences used for the second synchronization signal. The indication signaling may be based on one sequence out of a set of e.g. 127 different sequences. The indication signaling may be based on a pair of sequences out of a set of e.g. 127 different pairs of sequences. The number of sequences in the set of sequences may correspond e.g. to 3 or 127, or any other number e.g. a subset of 127. The indication signaling may be based on different sequences than the first and/or second synchronization signal. The indication signaling may be based on e.g. any one or more pseudo-random sequences and/or predefined sequences. The indication signaling may be mapped to resource elements using a complex conjugate. The indication signaling may be scrambled by another pseudo-random sequence when being mapped to the resource elements. The indication signaling may be scrambled by a pseudo-random noise sequence when being mapped to the resource elements. The pseudo-random sequence may be fixed or may be cell specific. The indication signaling may be based on the second synchronization signal (e.g. by being based on the same sequence(s)). The indication signaling may be based on the second synchronization signal, but transmitted in different time and frequency resources. The indication signaling may be based on the second synchronization signal, but using a different mapping to the resource elements, e.g. a complex conjugate and/or another pseudo-random sequence. The indication signaling may be used to assist the wireless device in detecting the second synchronization signal, which may reduce the acquisition time.

The method (300) may further comprise synchronizing with the first cell. The synchronization may be based on a combined processing of the indication signaling and the second synchronization signal. The indication signaling may use the same precoder as the second synchronization signal. The indication signaling may use the same mapping of indication signaling antenna ports to the physical antennas as the second synchronization signal. If the same precoder and/or mapping is used, the wireless device may coherently combine the auto-correlation of the indication signaling and the second synchronization signal to improve the overall synchronization performance. Furthermore, a joint processing of the indication signaling and the second synchronization signal may increase the probability of detection, which may reduce the acquisition time.

The synchronization may be based on separate processing of the indication signaling and the second synchronization signal. The indication signaling may use a different precoder than the second synchronization signal. The indication signaling may use a different mapping of the indication signaling antenna ports to the physical antennas than the second synchronization signal. If different precoders and/or mappings are used, the wireless device may process the auto-correlation of the indication signaling and the second synchronization signal independently to improve the overall synchronization performance.

In the method 300, the step 303 of accessing the cell may correspond to identifying the cell, e.g. by determining the cell identity. Accessing the cell may correspond to identifying the cell as a cell which supports wireless devices with specific capabilities. Accessing the cell may correspond to identifying the cell as a cell which supports wireless devices with specific capabilities and then further accessing the cell. Accessing the cell may correspond to synchronizing with the cell. Accessing the cell may correspond to synchronizing with the cell and then further accessing the cell. The indication signaling referred to in the method 300 may indicate to the wireless device that the cell supports wireless devices with specific capabilities without having to decode the system information on the broadcast channel and/or other system information. Accessing the cell may correspond to communicating with the network node. Accessing the cell may correspond to communicating with the network node using a reduced bandwidth.

In the method 300, the step 303 of accessing the cell may correspond to decoding a first system information message. The first information message may be decoded on the broadcast channel of the first cell. The first system information message may indicate time and frequency resources of a first resource set. The first system information message may correspond to the MIB. The broadcast channel may correspond to the PBCH. The first resource set may correspond to CORESET #0. Accessing the cell may correspond to decoding system information without decoding the first system information message on the broadcast channel. Accessing the cell may correspond to decoding system information without decoding the MIB on the PBCH. In the method 300, the step 303 of accessing the cell may correspond to decoding an extended system information message. The extended system information message may carry information specific for wireless devices with specific capabilities (such as e.g. reduced complexity, reduced cost, and/or reduced bandwidth). The extended system information may be decoded on time and frequency resources which are derived based on time and frequency resources of the first resource set and/or the first time and frequency resources. The extended system information may correspond to an enhanced MIB or eMIB. By detecting the indication signaling, the wireless device may know that the eMIB will be present. The time and frequency resources of the extended system information may be derived based on the time and frequency resources of the first resource set and/or the first time and frequency resources and some predefined rule and/or vector.

In the method 300, the step 303 of accessing the cell may correspond to decoding a first control channel in at least a subset of the time and frequency resources of the first resource set. The subset of the time and frequency resources may be derived based on the time and frequency resources of the first resource set. The subset of the time and frequency resources may be derived based on a predefined rule, e.g. being placed in the lowest frequencies of the time and frequency resources of the first resource set or e.g. being placed in the highest frequencies of the time and frequency resources of the first resource set. The time and frequency resources of the subset of the first resource set may have a narrower bandwidth than a bandwidth of the time and frequency resources of the first resource set. By detecting the indication signaling, the wireless device may know that the subset is allocated, and where it may find it. Hence, the wireless device may be able to decode the first control channel even though the first resource set may have a wider bandwidth than what the wireless device is capable of reading. The first control channel may correspond to a first Physical Downlink Control Channel (PDCCH).

In the method 300, the step 303 of accessing the cell may correspond to decoding a second control channel in a second resource set. The time and frequency resources of the second resource set may be derived based on the time and frequency resources of the first resource set. The time and frequency resources of the second resource set may have a narrower bandwidth than a bandwidth of the time and frequency resources of the first resource set. The time and frequency resources of the second resource set may overlap with the time and frequency resources of the first resource set. The time and frequency resources of the second resource set may not overlap with the time and frequency resources of the first resource set. The second resource set may correspond to CORESET #0-L, which may be a CORESET used for e.g. NR-Light UEs. The second control channel may correspond to a second PDCCH. By detecting the indication signaling, the wireless device may know that the second resource set is present and where it is allocated.

In the method 300, the step 303 of accessing the cell may correspond to decoding a first system information block based on the first control channel or the second control channel. The first system information block may carry information specific for wireless devices with reduced bandwidth. The first system information block may correspond to SIB1-L, which may correspond to a SIB1 used for e.g. NR-Light UEs.

The method (300) may further comprise estimating and/or measuring the signal quality of the first cell based on the indication signaling. The signal quality may correspond to a radio link quality, a Signal to Interference plus Noise Ratio (SINR), a Reference Signal Received Quality (RSRQ) and/or a Reference Signal Received Power (RSRP). The signal quality may correspond to a Synchronization Signal SS-SINR, a SS-RSRQ and/or a SS-RSRP. A specific Measurement Timing Configuration may be defined based on the indication signaling. The specific Measurement Timing Configuration may e.g. define a window over which measurements of the indication signaling is performed. The wireless device may perform other estimations and/or measurements based on the indication signaling. The wireless device may perform early mobility state measurements based on the indication signaling, e.g. when the indication signaling is transmitted over a plurality of OFDM symbols. The mobility state measurements may be derived without processing further signals. If it is determined, based on the early mobility state measurement, that the wireless device is stationary, a Radio Resource Management (RRM) measurement relaxation can be applied. The RRM measurement relaxation may allow the wireless device to measure using longer intervals and/or reducing the number of cells/carriers to measure on.

The method (300) may further comprise obtaining the identity of the first cell. The identity of the first cell may be based on the indication signaling. The identity of the first cell may be based on the indication signaling and one or more other signals, e.g. the first synchronization signal, the second synchronization signal, and/or a Demodulation Reference Signal (DMRS). The identity of the first cell may be based on the indication signaling and the first synchronization signal without detecting the second synchronization signal. The identity of the cell may be represented by using different sequences for the indication signaling. The identity of the cell may be derived by determining which sequence(s) out of the set of sequences that have been used. The indication signaling may be used to derive other information used for accessing the cell, e.g. information which would otherwise be decoded from the broadcast channel. The indication signaling may comprise redundancy coding or repetition coding of other information transmitted in the cell, e.g. repetition of the second synchronization signal.

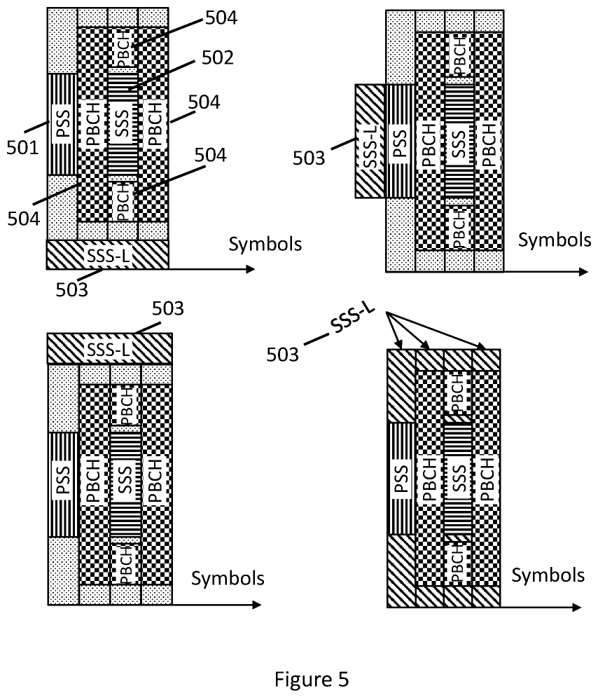

FIG. 4 is a flowchart illustrating a method (400) of operating a network node in a wireless communication system. The method (400) may comprise transmitting (401) first synchronization signaling on first time and frequency resources. The first synchronization signaling may comprise at least a first synchronization signal and a second synchronization signal. The method may further comprise transmitting (402) indication signaling on second time and frequency resources. The second time and frequency resources may be derived based on the first time and frequency resources. The method may further comprise communicating (403) with the wireless device based on the transmitted indication signaling.

Generally, features described in relation to the method 400 of operating the wireless device may have corresponding features for the method 300 of operating the network node described above with reference to FIG. 3. For example, the features of the synchronization signaling and the indication signaling may be the same or corresponding.

In the method 400, communicating may correspond to transmitting system information to the wireless device. Communicating may correspond to transmitting system information specific for wireless devices with specific capabilities to the wireless device. Communicating may correspond to transmitting system information over a reduced bandwidth. Communicating may correspond to transmitting and/or receiving data and/or control signaling to/from the wireless device. Communicating may correspond to transmitting and/or receiving data and/or control signaling to/from the wireless device with specific capabilities. Communicating may correspond to transmitting and/or receiving data and/or control signaling to/from the wireless device using a reduced bandwidth. Communicating may correspond to communicating with the wireless device over a reduced bandwidth. A reduced bandwidth may correspond to a bandwidth which is narrower than the bandwidth of the frequency band of the first cell. A reduced bandwidth may correspond to a bandwidth which is narrower than the bandwidth of the time and frequency resources of the first resource set. A reduced bandwidth may correspond to a bandwidth which is narrower than the bandwidth of CORESET #0.

In the method 400, transmitting the indication signaling may indicate to the wireless device that the network node supports wireless devices with specific capabilities (such as e.g. a reduced complexity, a reduced cost, and/or a reduced bandwidth). In one example, the network node may be a gNB which may support NR-Light UEs (e.g. UEs with reduced bandwidth). The gNB may transmit the indication signaling (e.g. an SSS-L signaling), which may indicate to the wireless device that the cell supports NR-Light UEs. By transmitting the indication signaling, the network node may enable a quick cell search for the wireless device. This may reduce the power consumption of the wireless device during the cell search.

In the method 400, the indication signaling may be based on one or more m-sequences. The indication signaling may be based on the same sequence as the first synchronization signal or the second synchronization signal. The indication signaling may be based on a different sequence than the first and/or second synchronization signal. The indication signaling and the second synchronization signal may use the same precoder. The indication signaling and the second synchronization signal may use different precoders.

In the method 400, the identity of a first cell of the network node may be based on the indication signaling and the first synchronization signal. The network node may determine which sequence(s) out of a set of sequences to base the indication signaling on. This determination may depend on the cell identity of the first cell of the network node. This determination may depend on other information such as e.g. information transmitted on the broadcast channel. This information may e.g. correspond to the system frame number (SFN). By transmitting the indication signaling based on a specific sequence(s), the network node may indicate the SFN and/or other information to the wireless device without e.g. the wireless device needing to decode the information on the broadcast channel.

The method 400 may further comprise transmitting a first system information message on a broadcast channel. The first system information message may indicate time and frequency resources of a first resource set.

The method 400 may further comprise transmitting an extended system information message. The extended system information message may carry information specific for wireless devices with reduced bandwidth.

The method 400 may further comprise transmitting a first control channel in at least a subset of the time and frequency resources of the first resource set. The subset of the time and frequency resources may be derived based on the time and frequency resources of the first resource set.

The method 400 may further comprise transmitting a second control channel in a second resource set. The time and frequency resources of the second resource set may be derived based on the time and frequency resources of the first resource set.

The method 400 may further comprise transmitting a first system information block. Time and frequency resources on which the first system information block is transmitted may be indicated by the first control channel or the second control channel. The first system information block may be based on the first control channel or the second control channel. The first system information block may carry information specific for wireless devices with reduced bandwidth.

The extended system information may be transmitted on time and frequency resources which are derived based on time and frequency resources of the first resource set and/or the first time and frequency resources.

The time and frequency resources of the subset of the first resource set may have a narrower bandwidth than a bandwidth of the time and frequency resources of the first resource set.

The time and frequency resources of the second resource set may have a narrower bandwidth than a bandwidth of the time and frequency resources of the first resource set.

The time and frequency resources of the second resource set may overlap with the time and frequency resources of the first resource set.

The time and frequency resources of the second resource set may not overlap with the time and frequency resources of the first resource set.

A wireless device configured for operation in a radio access network is disclosed. The wireless device may be implemented as a user equipment or a terminal. The wireless device may comprise, and/or be adapted to utilize, processing circuitry and/or radio front-end circuitry, in particular a transceiver and/or transmitter and/or receiver, for receiving the signaling (such as the signaling in steps 301 and 302 of the method 300) and accessing the cell (such as in step 303 in the method 300). The wireless device may be configured to perform any of the methods (300) of operating the wireless device as described above. The processing circuitry may be configured to perform any of the methods (300) of operating the wireless device as described above.

A network node configured for operation in a radio access network is disclosed. The network node may comprise, and/or be adapted to utilize, processing circuitry and/or radio front-end circuitry, in particular a transceiver and/or transmitter and/or receiver, for communicating, in particular for transmitting the signaling (such as the signaling in steps 401 and 402 of the method 400) and communicating with the wireless device (such as in step 403 of the method 400). The network node may be configured to perform any of the methods (400) of operating the network node as described above. The processing circuitry may be configured to perform any of the methods (400) of operating the network node as described above.

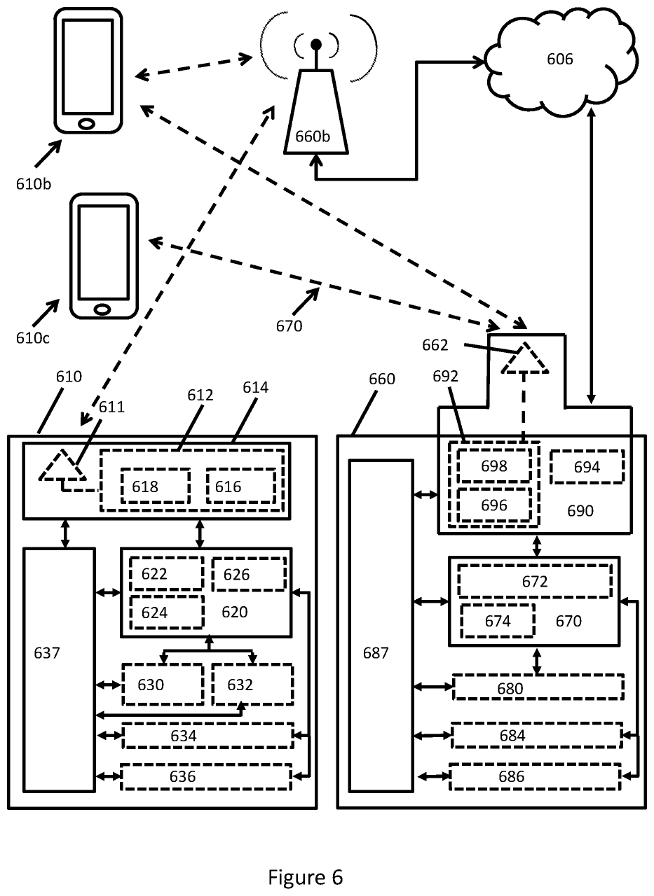

In one example, given in relation to FIG. 5, the wireless device is exemplified as an NR-Light UE (also referred to as NR-Redcap UE) which may try to access an NR cell which may or may not support NR-Light. Here, an SS S-L 503 (which is an example of the indication signaling referred to in the methods 300 and 400 described above with reference to FIGS. 3 and 4) is placed near or within the NR SSB (which is an example of the synchronization signaling referred to in the methods 300 and 400 described above with reference to FIGS. 3 and 4) as an indication of that the cell supports NR-Light service (e.g. by supporting a reduced bandwidth). In this way, the NR-Light UE can quickly identify whether the cell supports NR-Light without being required to read, e.g., the MIB in the PBCH and/or other system information. If the SSS-L is not found, the NR-Light UE can continue to search for another SSB of a new cell at another frequency. The term “SSS-L”, used as an example for the indication signaling, should be seen as an example for illustration purposes only. It should not be seen as a limitation of the signal design. FIG. 5 illustrates several different examples of the SSS-L 503 placements with respect to the NR SSB.

In one example, the NR-Light UE may detect the NR SSB. The NR SSB comprises a PSS 501 (which is an example of the first synchronization signal), an SSS 502 (which is an example of the second synchronization signal), and a PBCH 504 (which is an example of the broadcast channel). The SSB may be detected by detecting the PSS 501 and/or the SSS 502. If the SSB is detected, e.g. by detecting the PSS 501, the NR-Light UE may further check whether there is an SSS-L signal 503 present (e.g. by detecting the SSS-L signal 503). If there is an SSS-L signal 503 present, e.g. if the SSS-L 503 is detected, the NR-Light UE may try to access the cell e.g. by continuing to read and/or decoding the system information (e.g. MIB and/or SIB(s)). If the SSS-L signal 503 is not detected, the NR-Light UE may stop the procedure of accessing the cell and may instead search for another SSB of another cell at another frequency. If the SSS-L 503 is detected, the NR SSB together with the SSS-L 503 may be referred to as an NR-Light SSB.

In one example the NR-Light UE may detect the SSB by detecting the PSS and then may try to receive the SSS-L signal without reading the SSS.

In one example the NR-Light UE may detect the SSB by detecting both the PSS and the SSS, and then may try to detect the SSS-L signal.

The SSS-L signal may, in a more general case, be used to indicate that the system supports services in addition to the legacy NR service (e.g. NR Light and/or a reduced bandwidth and/or other additional services).

The presence of the SSS-L signal may be used to indicate the presence of a new MIB (e.g. an extended MIB or eMIB), which carries information relevant for the additional service. The eMIB may be an example of the extended system information. Therefore, in one example, when the NR-Light UE detects the SSS-L, it may search for the eMIB (different than the legacy MIB) and may access the cell by reading/decoding the necessary system information from the eMIB. The eMIB may contain information needed by the NR-Light UE for further accessing the cell. A legacy UE may not decode the eMIB.

In one example, the time and/or frequency location of the SSS-L signal may be derived from the time and/or frequency location of at least one of the PSS, the SSS, the PBCH, and/or the SSB. The time and/or frequency location may correspond to specific time and frequency resources.

In one example, the SSS-L may be placed before or after the PSS, SSS, PBCH, and/or SSB in time, either right before or right after the PSS, SSS, PBCH, and/or SSB without any gap, or with a gap. The gap may be specified in the specification, and e.g. preconfigured to the NR-Light UE. The frequency location of the SSS-L is derived based on the frequency location of the PSS, SSS, PBCH, and/or SSB, e.g., in the same frequency location as PSS, SSS, PBCH, and/or SSB or with some offset. The offset may be specified in the specification, and e.g. preconfigured to the NR-Light UE.

In one example, the SSS-L signal may be placed within the SSB, e.g. within the 20 RBs and the four OFDM symbols of the SSB. The SSS-L may use resource elements within the SSB that are not used by PSS, SSS, and/or PBCH.

In one example, the SSS-L signal may be based on one or more m-sequences. The SSS-L may be used by itself or together with one or more other signals, e.g., the PSS, the SSS, and/or a Demodulation Reference Signal (DMRS), to determine an identity of the cell (e.g. a Physical Layer Cell ID). In another example, the SSS-L signal may be based on an m-sequence made up of at least 127 values.

In one example, the SSS-L signal may use the same sequence(s) as the SSS. The SSS-L may be mapped to the resource elements by using a complex conjugate of the m-sequence(s).

In one example, the SSS-L is based on the same sequence(s) as the SSS but may in addition be scrambled by a pseudo-random noise sequence, which is different from the one used for SSS, when mapped to the resource elements. The scrambling sequence may be fixed or may be cell specific.

In one example, the SSS-L may use the same sequence(s) as the SSS but may be placed at a difference time and/or frequency location as the SSS.

In one example, the UE may assume that the network has configured the same mapping of the SSS-L antenna ports to the physical antennas, as it has for the SSS. A gNB (which is an example of the network node) may in other words use the same precoder for the SSS-L and SSS transmissions. This may allow a UE receiver to coherently combine the SSS-L and SSS auto-correlations to improve its overall synchronization performance.

In one example, the UE may assume that the network has not configured the same mapping of the SSS-L antenna ports to the physical antennas, as it has for the SSS. The gNB may in other words use different precoders for the SSS-L and SSS transmissions. This may allow a UE receiver to independently process the SSS-L and SSS auto-correlations to improve its overall synchronization performance.

In one example, a new NR MTC specific SSB Measurement Timing Configuration (SMTC) may be defined. It may be configured by the network to facilitate NR-Light UE SS-RSRP, SS-RSRQ and/or SS-SINR measurements. It may follow the 3GPP Release 15 SMTC definition and may be defined by a reoccurring time and frequency window used for measuring the SSS-L e.g. for the support of NR-Light mobility.

In one example, the SSS-L may be constituted of additional SSB repetitions which are beneficial to reduce the NR-Light UE energy consumption. A legacy UE may consider the SSB configurations as defined in Rel-15 and Rel-16 NR. An NR-Light UE may consider additional SSB instances in a time and/or frequency location which may not be confused with legacy SSB transmission. If the additional SSB instance is detected, the UE may interpret this an SSS-L indication and that NR-Light is supported in the cell.

In one example, information for quick acquisition may be repeated in SSS-L (e.g. selected content of SSB transmitted in SSS-L, e.g. with redundancy coding or simple repetition coding). This may further reduce UE energy consumption for NR-Light. In one example, if the NR-Light UEs have to accumulate over more SSB instances, repetition of SSS content in the SSS-L resources could be used for reduced acquisition time.

In one example, the SSS-L may be placed at the same time locations as the SSB. This may be done in order to not extend the reception time of the NR-Light UE, which may have a negative impact on the UE energy consumption and battery life. The amount of frequency resources used may depend on the bandwidth capability of NR-Light UEs. E.g. if 24 PRBs are supported by NR-Light UEs (4.32 MHz with 15 kHz subcarrier spacing), 4 PRBs may be used for SSS-L transmission.

In one example, the SSS-L may span over several OFDM symbols. In this case, the SSS-L may be used in early mobility state estimation (e.g. without having to process other signals). This may provide assisted information in RRM measurement relaxation determination.

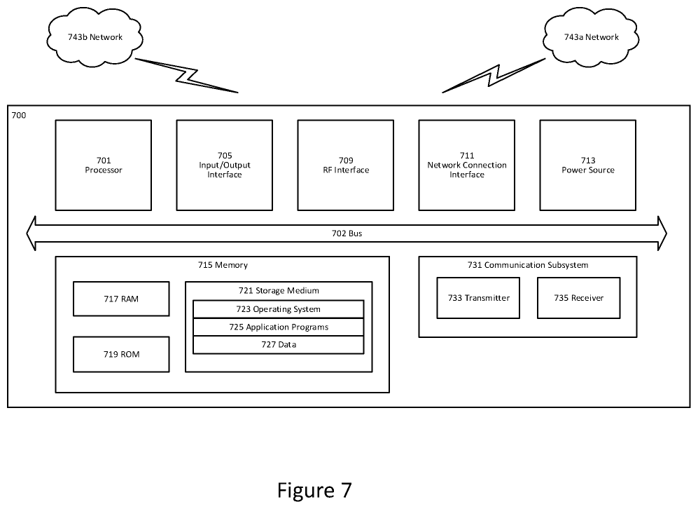

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and an RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signaling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. As one particular example, the WD may be a UE implementing the 3GPP NR-Light or NR MTC standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

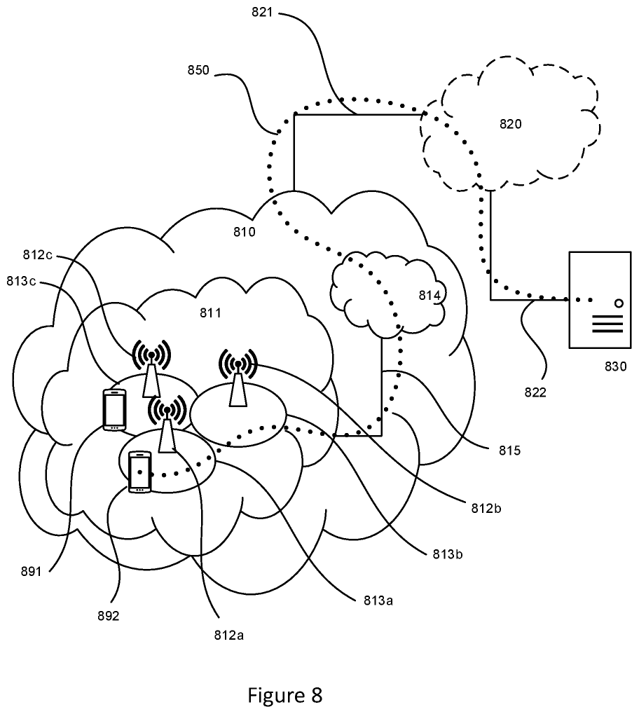

FIG. 7 illustrates one embodiment of a UE 700 in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3rd Generation Partnership Project (3GPP), including a NB-IoT UE, a machine type communication (MTC) UE, an enhanced MTC (eMTC) UE, a NR-Light UE, and/or an NR MTC UE. UE 700, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

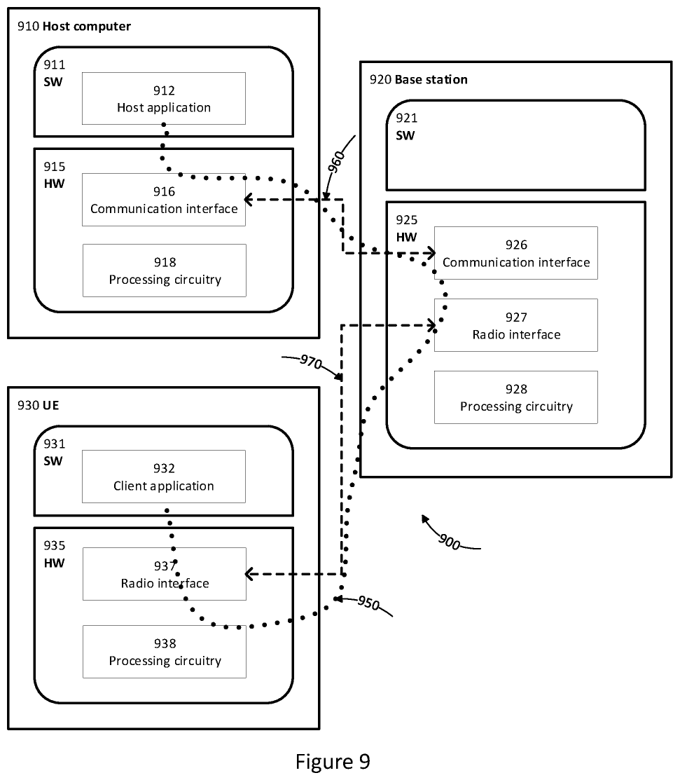

With reference to FIG. 8, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

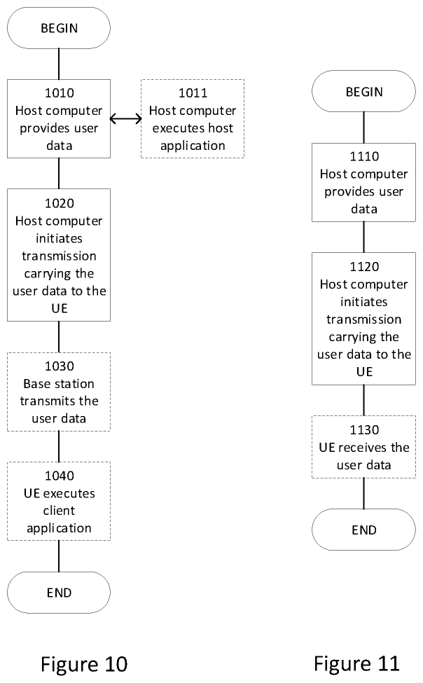

Example implementations, in accordance with an embodiment, of the UE, base station and host computer discussed in the preceding paragraphs will now be described with reference to FIG. 9. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may allow an increased battery life of the UE.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

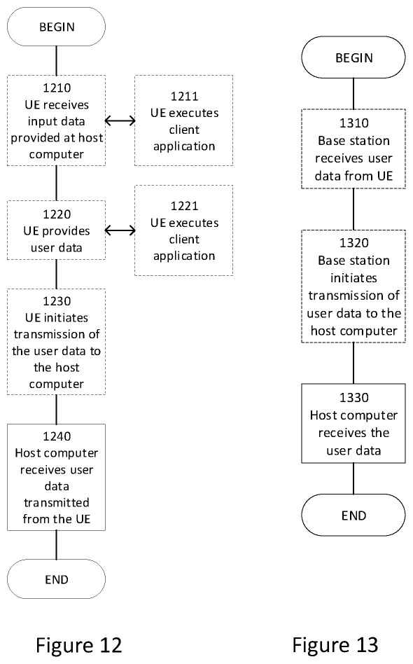

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 1210 (which may be optional), the UE receives input data provided by the host computer. Additionally, or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

### NUMBERED EMBODIMENTS

1. A method of operating a wireless device (610) in a wireless communication network, the method comprising:
   detecting (301) first synchronization signaling of a first cell on first time and frequency resources, the first synchronization signaling comprising at least a first synchronization signal and a second synchronization signal;
   detecting (302) indication signaling on second time and frequency resources, wherein the second time and frequency resources are derived based on the first time and frequency resources; and accessing (303) the first cell if the indication signaling is detected on the second time and frequency resources.
2. The method of embodiment 1, wherein the method further comprises:
   searching for another synchronization signaling of another cell if the indication signaling is not detected on the second time and frequency resources.
3. The method of any of embodiments 1-2, wherein detecting the first synchronization signaling involves detecting the first synchronization signal.
4. The method of any of embodiments 1-3, wherein detecting the first synchronization signaling involves detecting the first synchronization signal and the second synchronization signal.
5. The method of any of embodiments 1-4, wherein the second time and frequency resources are preconfigured based on the first time and frequency resources.
6. The method of any of embodiments 1-5, wherein the indication signaling is based on one or more m-sequences.
7. The method of any of embodiments 1-6, wherein the indication signaling is based on the same sequence as the first synchronization signal or the second synchronization signal.
8. The method of any of embodiments 1-7, wherein the indication signaling is based on a different sequence than the first and/or second synchronization signal.
9. The method of any of embodiments 1-8, wherein the method further comprising:
   synchronizing with the first cell based on a combined processing of the indication signaling and the second synchronization signal, or separate processing of the indication signaling and the second synchronization signal.
10. The method of any of embodiments 1-9, wherein the method further comprising:
   estimating a signal quality of the first cell based on the indication signaling.
11. The method of any of embodiments 1-10, wherein the method further comprising:
   obtaining the identity of the first cell, wherein the identity of the first cell is based on at least the indication signaling.
12. The method of embodiment 11, wherein the identity of the first cell is based on the indication signaling and the first synchronization signal.
13. The method of any of embodiments 1-12, wherein accessing the first cell comprises at least one of:
   decoding a first system information message on a broadcast channel of the first cell, wherein the first system information message indicates time and frequency resources of a first resource set;
   decoding an extended system information message, wherein the extended system information message carries information specific for wireless devices with reduced bandwidth;
   decoding a first control channel in at least a subset of the time and frequency resources of the first resource set, wherein the subset of the time and frequency resources are derived based on the time and frequency resources of the first resource set;
   decoding a second control channel in a second resource set, wherein the time and frequency resources of the second resource set are derived based on the time and frequency resources of the first resource set;
   decoding a first system information block based on the first control channel or the second control channel, wherein the first system information block carries information specific for wireless devices with reduced bandwidth.
14. The method of embodiment 13, wherein the extended system information is decoded on time and frequency resources which are derived based on time and frequency resources of the first resource set and/or the first time and frequency resources.
15. The method of any of embodiments 13-14, wherein the time and frequency resources of the subset of the first resource set has a narrower bandwidth than a bandwidth of the time and frequency resources of the first resource set.
16. The method of any of embodiments 13-15, wherein the time and frequency resources of the second resource set has a narrower bandwidth than a bandwidth of the time and frequency resources of the first resource set.
17. The method of any of embodiments 13-16, wherein the time and frequency resources of the second resource set overlap with the time and frequency resources of the first resource set.
18. The method of any of embodiments 13-17, wherein the time and frequency resources of the second resource set do not overlap with the time and frequency resources of the first resource set.
19. A method of operating a network node (660) in a wireless communication network, the method comprising:
   transmitting (401) first synchronization signaling on first time and frequency resources, the first synchronization signaling comprising at least a first synchronization signal and a second synchronization signal;
   transmitting (402) indication signaling on second time and frequency resources, wherein the second time and frequency resources are derived based on the first time and frequency resources;
   communicating (403) with the wireless device (610) based on the transmitted indication signaling.
20. The method of embodiment 19, wherein the indication signaling is based on one or more m-sequences.
21. The method of any of embodiments 19-20, wherein the indication signaling is based on the same sequence as the first synchronization signal or the second synchronization signal.
22. The method of any of embodiments 19-21, wherein the indication signaling is based on a different sequence than the first and/or second synchronization signal.
23. The method of any of embodiments 19-22, wherein the indication signaling and the second synchronization signal uses the same precoder.
24. The method of any of embodiments 19-22, wherein the indication signaling and the second synchronization signal uses different precoders.
25. The method of any of embodiments 19-24, wherein an identity of a first cell of the network node (660) is based on the indication signaling and the first synchronization signal.
26. The method of any of embodiments 19-25, wherein the method further comprises at least one of:
   transmitting a first system information message on a broadcast channel, wherein the first system information message indicates time and frequency resources of a first resource set;
   transmitting an extended system information message, wherein the extended system information message carries information specific for wireless devices with reduced bandwidth;
   transmitting a first control channel in at least a subset of the time and frequency resources of the first resource set, wherein the subset of the time and frequency resources are derived based on the time and frequency resources of the first resource set;
   transmitting a second control channel in a second resource set, wherein the time and frequency resources of the second resource set are derived based on the time and frequency resources of the first resource set; and
   transmitting a first system information block, wherein the first system information block is based on the first control channel or the second control channel, and wherein the first system information block carries information specific for wireless devices with reduced bandwidth.
27. The method of embodiment 26, wherein the extended system information is transmitted on time and frequency resources which are derived based on time and frequency resources of the first resource set and/or the first time and frequency resources.
28. The method of any of embodiments 26-27, wherein the time and frequency resources of the subset of the first resource set has a narrower bandwidth than a bandwidth of the time and frequency resources of the first resource set.
29. The method of any of embodiments 26-28, wherein the time and frequency resources of the second resource set has a narrower bandwidth than a bandwidth of the time and frequency resources of the first resource set.
30. The method of any of embodiments 26-29, wherein the time and frequency resources of the second resource set overlap with the time and frequency resources of the first resource set.
31. The method of any of embodiments 26-30, wherein the time and frequency resources of the second resource set do not overlap with the time and frequency resources of the first resource set.
32. A wireless device (610) configured for operation in a radio access network, the wireless device (610) being configured to perform the method according to any of embodiments 1-18.
33. A wireless device (610) configured for operation in a radio access network, the wireless device (610) comprising:
   processing circuitry configured to perform any of the steps of any of embodiments 1-18.
34. A wireless device (610) configured for operation in a radio access network, the wireless device (610) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of embodiments 1-18;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
35. A network node (660) configured for operation in a radio access network, the network node (660) being configured to perform the method according to any of embodiments 19-31.
36. A network node (660) configured for operation in a radio access network, the network node (660) comprising:
   processing circuitry configured to perform any of the steps of any embodiments 19-31.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5G 5th Generation
ABS Almost Blank Subframe
AL Aggregation Level
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CORESET Control Resource Set
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DCI Downlink Control Indicator
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
MTC Machine Type Communication
cMTC critical MTC
eMTC enhanced MTC
mMTC massive MTC
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
QAM Quadrature Amplitude Modulation
RACH Random Access Channel
RAN Radio Access Network
RAR Random Access Response
RAT Radio Access Technology
RB Resource Block
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TA Timing Advance
TDD Time Division Duplex
TDOA Time Difference of Arrival
TOA Time of Arrival
TOF Time of Flight
TSN Time Sensitive Networking
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1. A method of operating a wireless device in a wireless communication network, the method comprising:
detecting first synchronization signaling of a first cell on first time and frequency resources, the first synchronization signaling comprising at least a first synchronization signal and a second synchronization signal;
detecting indication signaling on second time and frequency resources, wherein the second time and frequency resources are derived based on the first time and frequency resources; and
accessing the first cell if the indication signaling is detected on the second time and frequency resources, accessing the first cell comprising:
decoding a first system information message on a broadcast channel of the first cell, the first system information message indicating time and frequency resources of a first resource set.

2. (canceled)

3. (canceled)

4. The method of claim 1, wherein the first system information message is a Master Information Block, MIB

5. The method of claim 1, wherein the method further comprises:
searching for another synchronization signaling of another cell if the indication signaling is not detected on the second time and frequency resources.

6. The method of claim 1, wherein the method further comprises:
estimating a signal quality of the first cell based on the indication signaling.

7. The method of claim 1, wherein the method further comprises:
obtaining the identity of the first cell based on at least the indication signaling.

8. The method of claim 7, wherein the identity of the first cell is obtained based on the indication signaling and the first synchronization signal.

9.-11. (canceled)

12. The method of claim 1, wherein the indication signaling is based on one or more m-sequences.

13. (canceled)

14. (canceled)

15. The method of claim 1, wherein the method further comprises:
synchronizing with the first cell based on one of:
a combined processing of the indication signaling and the second synchronization signal; and
separate processing of the indication signaling and the second synchronization signal.

16. The method of claim 1, wherein accessing the first cell comprises at least one of:
decoding an extended system information message, wherein the extended system information message carries information specific for wireless devices with reduced bandwidth;
decoding a first control channel in at least a subset of the time and frequency resources of the first resource set, wherein the subset of the time and frequency resources is derived based on the time and frequency resources of the first resource set;
decoding a second control channel in a second resource set, wherein the time and frequency resources of the second resource set are derived based on the time and frequency resources of the first resource set;
decoding a first system information block based on the first control channel or the second control channel, wherein the first system information block carries information specific for wireless devices with reduced bandwidth.

17. The method of claim 16, wherein the extended system information message is decoded on time and frequency resources which are derived based on time and frequency resources of the first resource set and/or the first time and frequency resources.

18. The method of claim 16, wherein the time and frequency resources of the subset of the first resource set has a narrower bandwidth than a bandwidth of the time and frequency resources of the first resource set.

19. The method of claim 16, wherein the time and frequency resources of the second resource set has a narrower bandwidth than a bandwidth of the time and frequency resources of the first resource set.

20. The method of claim 16, wherein the time and frequency resources of the second resource set overlap with the time and frequency resources of the first resource set.

21. The method of claim 16, wherein the time and frequency resources of the second resource set do not overlap with the time and frequency resources of the first resource set.

22. A method of operating a network node in a wireless communication network, the method comprising:
transmitting first synchronization signaling on first time and frequency resources, the first synchronization signaling comprising at least a first synchronization signal and a second synchronization signal;
transmitting indication signaling on second time and frequency resources, wherein the second time and frequency resources are derived based on the first time and frequency resources;
transmitting a first system information message on a broadcast channel, the first system information message indicating time and frequency resources of a first resource set; and
communicating with a wireless device based on the transmitted indication signaling.

23. (canceled)

24. (canceled)

25. The method of claim 22, wherein the first system information message is a Master Information Block, MIB.

26.-31. (canceled)

32. The method of claim 22, wherein the indication signaling and the second synchronization signal use different precoders.

33. The method of claim 22, wherein the method further comprises at least one of:
transmitting an extended system information message, wherein the extended system information message carries information specific for wireless devices with reduced bandwidth;
transmitting a first control channel in at least a subset of the time and frequency resources of the first resource set, wherein the subset of the time and frequency resources is derived based on the time and frequency resources of the first resource set;
transmitting a second control channel in a second resource set, wherein the time and frequency resources of the second resource set are derived based on the time and frequency resources of the first resource set; and
transmitting a first system information block, wherein time and frequency resources on which the first system information block is transmitted are indicated by the first control channel or the second control channel, and wherein the first system information block carries information specific for wireless devices with reduced bandwidth.

34.-40. (canceled)

41. A wireless device configured for operation in a radio access network, the wireless device comprising processing circuitry configured to:
detect first synchronization signaling of a first cell on first time and frequency resources, the first synchronization signaling comprising at least a first synchronization signal and a second synchronization signal;
detect indication signaling on second time and frequency resources, the second time and frequency resources being derived based on the first time and frequency resources; and
access the first cell if the indication signaling is detected on the second time and frequency resources, accessing the first cell comprising:
decoding a first system information message on a broadcast channel of the first cell, the first system information message indicating time and frequency resources of a first resource set.

42.-44. (canceled)

45. A network node configured for operation in a radio access network, the network node comprising processing circuitry configured to:
transmit first synchronization signaling on first time and frequency resources, the first synchronization signaling comprising at least a first synchronization signal and a second synchronization signal;
transmit indication signaling on second time and frequency resources, the second time and frequency resources being derived based on the first time and frequency resources;
transmit a first system information message on a broadcast channel, the first system information message indicating time and frequency resources of a first resource set; and
communicate with a wireless device based on the transmitted indication signaling.

46. (canceled)
